(19) United States
(12) Patent Application Publication
(10) Pub. No.: US 2024/0394313 A1
(43) Pub. Date: Nov. 28, 2024

(54) RELATED-INFORMATION DISPLAY DEVICE, NON-TRANSITORY COMPUTER-READABLE STORAGE MEDIUM, AND RELATED-INFORMATION DISPLAY METHOD

(71) Applicant: Mitsubishi Electric Corporation, Tokyo (JP)

(72) Inventors: Kumiko IKEDA, Tokyo (JP); Yusuke KOJI, Tokyo (JP); Tatsuhiko SAITO, Tokyo (JP); Kunio NARIMASA, Tokyo (JP); Hirofumi FUKAGAWA, Tokyo (JP); Maki ITO, Tokyo (JP)

(73) Assignee: Mitsubishi Electric Corporation, Tokyo (JP)

(21) Appl. No.: 18/791,607

(22) Filed: Aug. 1, 2024

Related U.S. Application Data
(63) Continuation of application No. PCT/JP2022/017063, filed on Apr. 4, 2022.

(51) Int. Cl. G06F 16/904

(52) U.S. Cl. CPC G06F 16/904

(57) ABSTRACT

A related-information display device includes: a knowledge graph DB that stores a knowledge graph holding knowledge information with a plurality of nodes and links connecting the nodes; a related-information inference unit that infers related information related to a keyword from the knowledge graph; a relatedness calculation unit calculates relatedness between the keyword and the related information; and a display-data generation unit that generates display data for displaying a flow rate diagram indicating a relationship between the keyword and the related information related to the keyword by connecting the keyword and the related information with a band, wherein the width of the band increases as the relatedness increases.

### CROSS REFERENCE TO RELATED APPLICATION

This application is a continuation application of International Application No. PCT/JP2022/017063 having an international filing date of Apr. 4, 2022.

### BACKGROUND OF THE INVENTION

### 1. Field of the Invention

The disclosure relates to a related-information display device, a non-transitory computer-readable storage medium, and a related-information display method.

### 2. Description of the Related Art

Conventionally, there has been a technique for holding specialized knowledge information in a database (DB) using knowledge graphs representing related events or relationships of knowledge, searching the knowledge information, and presenting the retrieved information. For example, PTL 1 describes a method of extracting words or phrases from an inputted document, extracting knowledge from a knowledge graph, which is conceptual structure information related to the extracted words or phrases, by specifying search conditions or the DB to be searched on the basis of conditions specified by a user, and converting the extracted knowledge into a graph structure or text.
Patent Literature 1: Japanese Patent Application Publication No. 2020-140604

### SUMMARY OF THE INVENTION

With the conventional technique, the results of extracting data from a knowledge graph are directly presented as a graph structure in order to represent their relationships.

However, there is a problem in presenting the results in the form of a graph structure because, unless the user has understanding in graph structures, a graph structure is difficult to understand or the relationship between extracted results and the inputted data is difficult to read.

Accordingly, an object of one or more aspects of the disclosure is to present, in an easy-to-understand manner, the relationship between a keyword and knowledge extracted from a knowledge graph by using the keyword, even when a user does not have enough understanding in knowledge graph structures.

A related-information display device according to an aspect of the disclosure includes: a processor to execute a program; and a memory to store the program which, when executed by the processor, performs a process of, generating display data for displaying a flow rate diagram indicating a relationship between a keyword and related information related to the keyword by connecting the keyword and the related information with a band. The width of the band increases as the relationship becomes stronger.

According to one or more aspects of the disclosure, it is possible to present, in an easy-to-understand manner, the relationship between a keyword and knowledge extracted from a knowledge graph by using the keyword, even when a user does not have enough understanding in knowledge graph structures.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a related-information display device according to a first embodiment;

FIG. 2 is a schematic diagram illustrating the structure, or ontology, of a knowledge graph centered around a document;

FIG. 3 is a schematic diagram illustrating a first example of a knowledge graph;

FIG. 4 is a schematic diagram illustrating a first example of a Sankey diagram;

FIG. 5 is a schematic diagram illustrating a first example of a subgraph;

FIG. 6 is a schematic diagram illustrating a second example of a subgraph;

FIG. 7 is a table summarizing the relatedness between an input query and related information, or a search result;

FIG. 8 is a schematic diagram illustrating a second example of a knowledge graph;

FIG. 9 is a schematic diagram illustrating a third example of a subgraph;

FIG. 10 is a schematic diagram illustrating a second example of a Sankey diagram;

FIG. 11 is a block diagram schematically illustrating a hardware configuration example;

FIG. 12 is a flowchart illustrating operation of the related-information display device according to the first embodiment;

FIG. 13 is a block diagram schematically illustrating a configuration of a related-information display device according to a second embodiment;

FIG. 14 is a schematic diagram illustrating a third example of a Sankey diagram;

FIG. 15 is a schematic diagram illustrating a fourth example of a Sankey diagram;

FIG. 16 is a schematic diagram illustrating a fourth example of a subgraph;

FIG. 17 is a flowchart illustrating operation of the related-information display device according to the second embodiment;

FIG. 18 is a schematic diagram illustrating a fifth example of a Sankey diagram;

FIG. 19 is a schematic diagram illustrating a sixth example of a Sankey diagram;

FIG. 20 is a block diagram schematically illustrating a configuration of a related-information display device according to a third embodiment;

FIG. 21 is a flowchart illustrating operation of the related-information display device according to the third embodiment;

FIG. 22 is a block diagram schematically illustrating a configuration of a related-information display device according to a fourth embodiment;

FIG. 23 is a block diagram schematically illustrating a configuration of a related-information display device according to a fifth embodiment;

FIG. 24 is a schematic diagram illustrating an example of a popup displaying detailed information; and

FIG. 25 is a schematic diagram illustrating an example in which band information is displayed as detailed information.

### DETAILED DESCRIPTION OF THE INVENTION

### First Embodiment

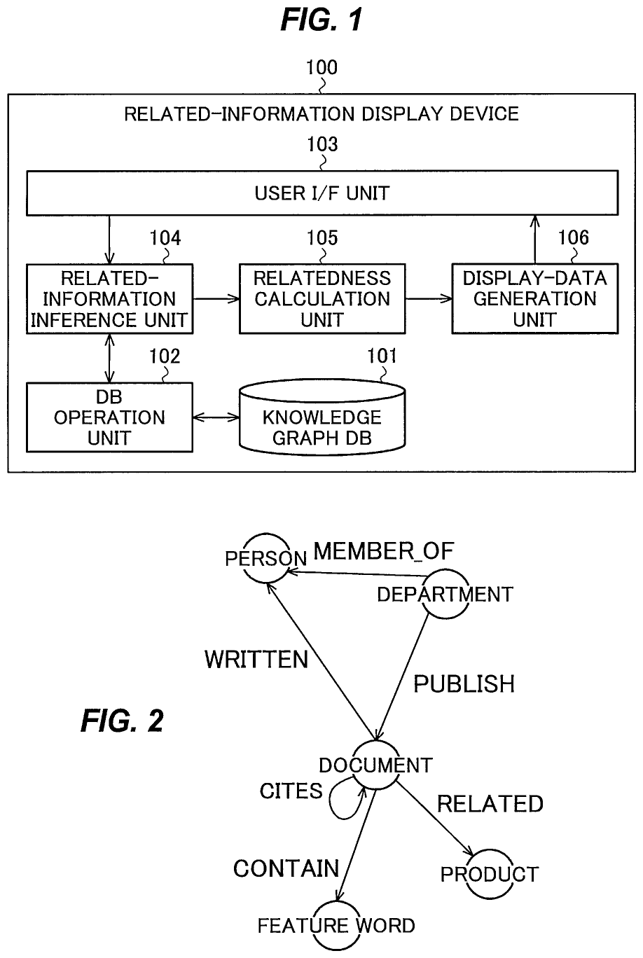

FIG. 1 is a block diagram schematically illustrating a configuration of a related-information display device 100 according to the first embodiment.

The related-information display device 100 includes a knowledge graph database (DB) 101, a DB operation unit 102, a user interface (I/F) unit 103, a related-information inference unit 104, a relatedness calculation unit 105, and a display-data generation unit 106.

The knowledge graph 101 DB holds knowledge information. For example, the knowledge graph DB 101 is a knowledge graph database holding knowledge information in a graph structure with nodes representing knowledge information obtained in advance and links representing relationships between the nodes. In other words, the knowledge graph DB 101 functions as a knowledge-graph storage unit that stores knowledge graphs holding knowledge information with multiple nodes and links connecting the nodes.

There are various formats of knowledge graphs, such as Property Graph and Resource Description Framework (RDF). In the description below, knowledge graphs are presented in Property Graph. However, the knowledge graphs may be in other graph formats. Here, the knowledge graph DB 101 holds knowledge information obtained from business documents, such as design documents and dissertations, as knowledge graphs.

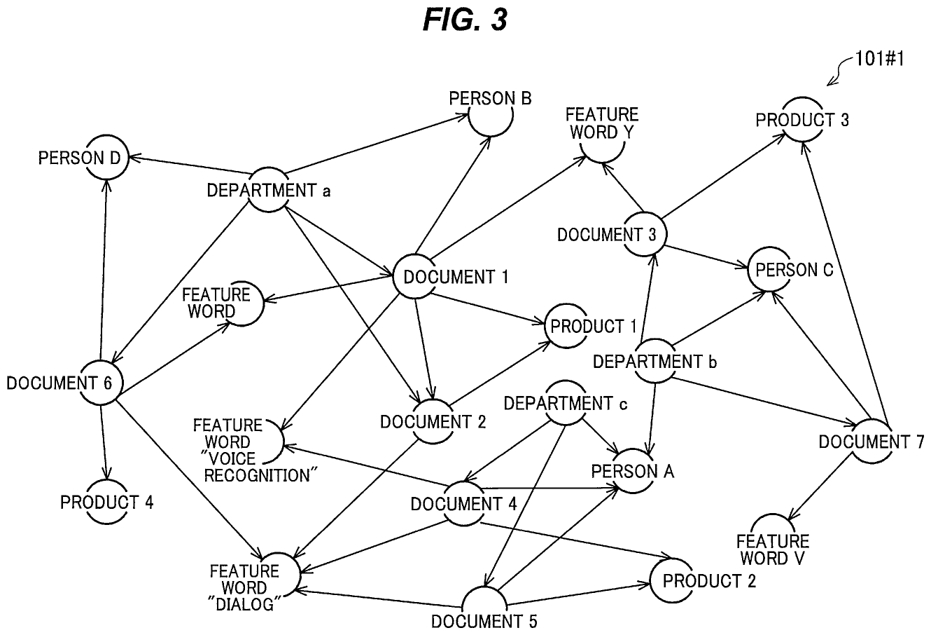

FIGS. 2 and 3 are schematic diagrams for explaining the knowledge graph according to the first embodiment.

FIG. 2 is a schematic diagram illustrating the structure, or ontology, of a knowledge graph centered around a document.

FIG. 3 is a schematic diagram illustrating an example knowledge graph.

In FIG. 2, nodes represent information on information types such as “document,” “person,” “department,” “product,” and “feature word”; and the relationship between “document” and “author” is denoted as “WRITTEN,” the relationship between “document” and “department,” which issues the “document,” is denoted as “PUBLISH,” the relationship between “product” and “document,” which is related to the “product,” is denoted as “RELATED,” the relationship between “person” and “department” to which the “person” belongs is denoted as “MEMBER OF,” and the relationship between “document” and “feature word,” which is included in “document,” is denoted as “CONTAIN.” Here, the information type “feature word” refers to words that represent the content of a document. Each node in a knowledge graph always has a defined information type.

A knowledge graph 101 #1 illustrated in FIG. 3 holds knowledge information obtained from documents and information related to the documents in the form of a graph based on the ontology illustrated in FIG. 2.

The knowledge graph 101 #1 illustrated in FIG. 3 is an example that holds knowledge information related to business documents, but the knowledge graph 101 #1 is a mere example and alternatively may hold other information.

Referring back to FIG. 1, the DB operation unit 102 operates the knowledge graph DB 101. For example, the DB operation unit 102 operates the knowledge graph DB 101 to register, update, or delete knowledge therein and search the knowledge therein under specified conditions. The DB operation unit 102 performs processing corresponding to the type of the knowledge graph DB 101, receives keywords as input queries and the type of information to be retrieved from the related-information inference unit 104, and performs the search by a specified search method. For example, the DB operation unit 102 employs a search method of searching knowledge connected via specific route paths based on the knowledge graph structure.

The user I/F unit 103 functions as an interface unit that acquires keywords and information types. Here, the user I/F unit 103 functions as an input accepting unit that accepts input from a user, and a display processing unit that displays related information. For example, the user I/F unit 103 accepts input from a user via an input device (not illustrated), such as a keyboard or mouse, that functions as an input unit, and passes an accepted input query to the related-information inference unit 104. The user I/F unit 103 then presents related information and its relatedness to a user on a display that functions as a display unit on the basis of the display data received from the display-data generation unit 106.

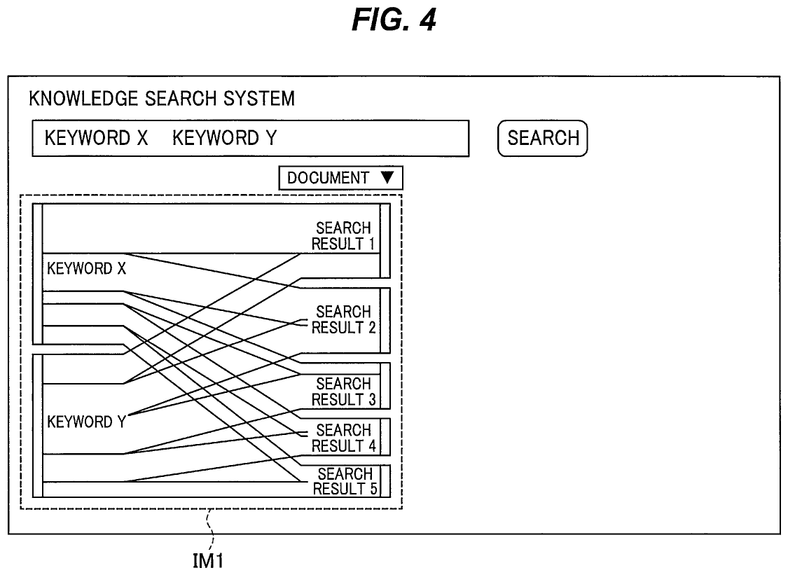

In other words, the user I/F unit 103 presents a search screen that allows a user to retrieve related information, and accepts input from the user of keywords, information type that are the types of information to which the keywords belong, and information type that is the type of the information to be retrieved. Then, on the basis of the display data, the user I/F unit 103 uses a flow rate diagram representing the flow rates between processes represented by a Sankey diagram IM1, such as that illustrated in FIG. 4, to present to a user the relatedness between the input queries and the related information.

Here, the display data from the display-data generation unit 106 at least includes one or more keyword or input query, related information that is the search results, the width of a band connecting each keyword and its search result, and width information used for displaying the keyword and its search result. On the basis of this information, the user I/F unit 103 displays related information on the display unit in the form of the Sankey diagram IM1.

The Sankey diagram IM1 illustrates keywords that are input queries, related information, and bands connecting the keywords and the related information.

The input queries are arrayed on the left side of the Sankey diagram IM1, and the pieces of related information are arrayed on the right side of the Sankey diagram IM1; the width of a band connecting a keyword and related information increases as the relatedness between the keyword and the related information increases.

At this time, the pieces of related information may be arranged in descending order of band width from the top. In this way, information that is closely related to a keyword is positioned toward the top to enable easy viewing of the results.

When the pieces of related information can be grouped, as in grouping pieces of information on persons and their affiliation information, such pieces of information may be displayed collectively as a group. This allows a user to grasp a collection of related information and easily view the results.

Referring back to FIG. 1, when the user I/F unit 103 is implemented as, for example, a web application, a user accesses a specific uniform resource locator (URL) with a browser to display a search screen. The user then inputs keywords by using a keyboard. The related information obtained on the basis of the user input is provided in the form of a Sankey diagram on a Web browser displayed on a display. Additionally, user input may be accepted by voice.

In the example illustrated in FIG. 4, the flow rate diagram is displayed in two dimensions, but alternatively, it may be displayed in three dimensions. For example, when multiple types of related information, such as persons and documents related to inputted keywords, are to be displayed at once, the relationships of the related information can be displayed for each information type by showing the relationships with the persons are in the transverse direction, and the connections with the documents in the depth direction.

The related-information inference unit 104 infers related information related to a keyword from a knowledge graph stored in the knowledge graph DB 101. Here, the related-information inference unit 104 receives user input and infers related information. For example, the related-information inference unit 104 uses the DB operation unit 102 to extract related information desired by the user on the basis of keywords, or input queries, and the information type of the information to be retrieved which are inputted by the user. Here, the related-information inference unit 104 infers information related to the keywords and belonging to the information type as related information.

Specifically, the related-information inference unit 104 specifies a path route to be searched on the basis of the knowledge graph structure, to extract related information. For example, when a user wants to retrieve information on a “person” who has knowledge in “voice recognition” and “dialogue,” the related-information inference unit 104 uses the DB operation unit 102 to extract authors of documents containing the term “voice recognition” as feature words and authors of documents containing the word “dialogue” as a feature word, and infers persons belong to both groups of authors as related persons, which are related information. In other words, the related-information inference unit 104 infers related information by selecting an inference method corresponding to the related information desired by a user.

The related-information inference unit 104 may also infer the authors of documents containing both feature words “voice recognition” and “dialogue” as related persons. Furthermore, when a graph structure assumed for each information type specified as the type of information to be retrieved by a user is stored, the related-information inference unit 104 may extract a subgraph similar to that graph structure and determine the nodes of the information type specified as information to be retrieved included in the subgraph as related information. Alternatively, the related-information inference unit 104 may extract the related information by calculating a shortest route path from an input query. The related-information inference unit 104 may also extract related information by using other methods.

Furthermore, instead of a user specifying a specific information type, the related-information inference unit 104 may present information of various information types as related information. For example, the related-information inference unit 104 may use a graph structure to extract information within a specified number of hops from a keyword as related information. The related-information inference unit 104 may predetermine the information type of the information to be extracted in accordance with the information type of the inputted query, and extract only relevant data.

The relatedness calculation unit 105 calculates the relatedness between keywords and related information. Here, the relatedness calculation unit 105 calculates the relatedness between an inputted keyword and an inference result of related information. For example, the relatedness calculation unit 105 uses the retrieval results of related information extracted by the related-information inference unit 104 and the graph structure of a knowledge graph used for extraction, to calculate the relatedness between the keywords, which are inputted queries, and the extracted related information.

A specific example of process of calculating relatedness will now be explained for a case in which “Person A” and “Person B” are extracted as related persons, which are information related to “dialogue” and “voice recognition.”

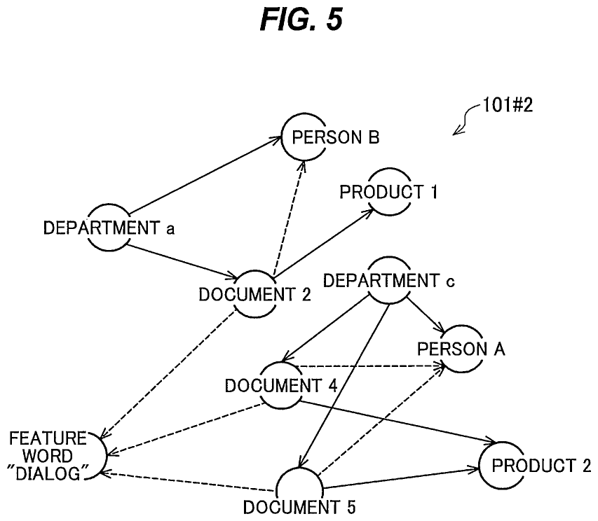

For example, when relatedness is to be defined by the number of documents between a keyword, or feature word, and a person, the relatedness between “dialogue” and each related person in the knowledge graph 101 #1 in FIG. 3 is determined on the basis of the structure of a subgraph 101 #2, such as that illustrated in FIG. 5; specifically, the degree of relatedness between “dialogue” and “Person A” is “2” because “dialogue” and “person A” are connected via “Document 4” and “Document 5.” Moreover, the degree of relatedness between “dialogue” and “Person B” is “1” because “dialogue” and “Person B” are connected via “Document 1.”

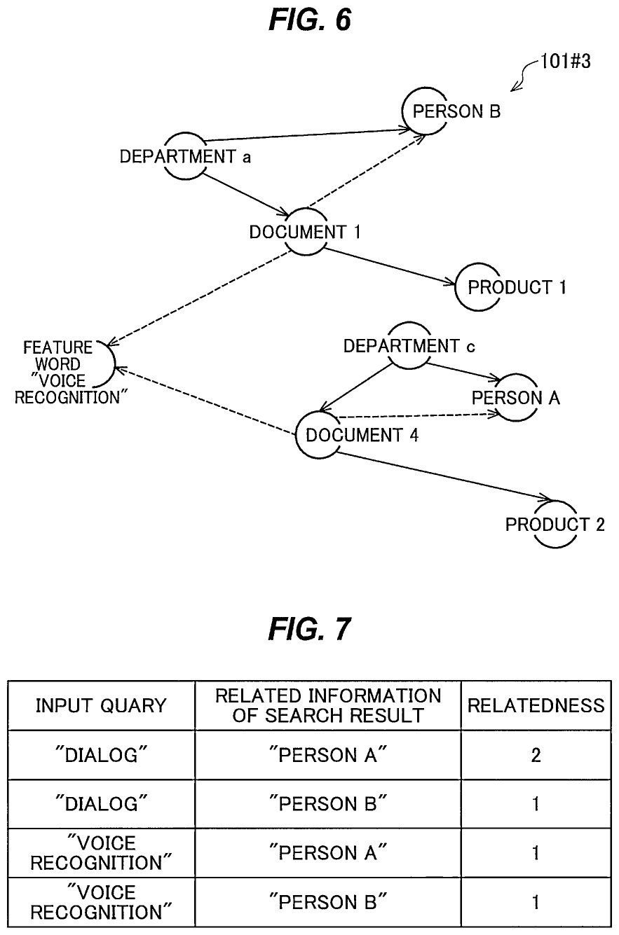

Similarly, the degree of relatedness between “voice recognition” and “Document 4” is determined to be “1” on the basis of the structure of a subgraph 101 #3, such as that illustrated in FIG. 6, because “voice recognition” is connected to “Person A” via “Document 4.” Moreover, the degree of relatedness between “voice recognition” and “Person B” is determined to be “1” because “voice recognition” is connected to “Person B” via “Document 1.” The relatedness between an input query and related information, or a search result, is summarized in FIG. 7.

In the above example, the relatedness calculation unit 105 calculates the number of documents to be relayed as the degree of relatedness on the basis of a node structure, but alternatively, a degree of importance may be set for the documents, and the degree of relatedness may be calculated as the sum of the degrees of importance of the documents to be relayed. Alternatively, the relatedness calculation unit 105 may calculate the degree of relatedness by calculating the degrees of importance of keywords in the documents by using term frequency-inverse document frequency (TF-IDF) or the like and summing the calculation results. Alternatively, the relatedness calculation unit 105 may calculate the sum of link weights set by using PageRank as the degree of relatedness between an input query and related information. Alternatively, the relatedness calculation unit 105 may change the calculation method for each type of node. Alternatively, the relatedness calculation unit 105 may calculate the degree of relatedness by combining several methods. Moreover, the relatedness calculation unit 105 may perform calculation by using information other than that described herein.

The display-data generation unit 106 generates display data for displaying a flow rate diagram indicating the relationship between a keyword and the related information of the keyword by connecting the keyword and the related information with a band. Here, the width of the band increases as the degree of relatedness increases. The flow rate diagram is, for example, a Sankey diagram, and the width of the bands is assumed to be normalized on the basis of the width of the displayed keyword.

In the first embodiment, the display-data generation unit 106 generates display data, which is data for display, on the basis of related information and relatedness. For example, the display-data generation unit 106 generates display data necessary for illustrating the relatedness between keywords and related information in a Sankey diagram on the basis of the related information received from the related-information inference unit 104 and the relatedness received from the relatedness calculation unit 105. Display data includes at least one or more keywords that are input queries, related information that is search results, bands connecting the inputted keywords and the search results, and information on the respective widths necessary for displaying these. In addition, colors necessary for display, information showing display position relationships, or the like may be included in the display data.

Specifically, the display-data generation unit 106 normalizes the width of a band connecting each keyword and each piece of related information for each keyword by using the degree of relatedness calculated by the relatedness calculation unit 105. In other words, the display-data generation unit 106 calculates a value obtained by dividing the width of a keyword in proportion to the relatedness of the keyword and its related information as the band width, and the width of the related information node is defined as the sum of the widths of the bands connected to that node. At this time, degree of importance of the keywords inputted by the user are assumed to be the same, and thus the widths of the keywords are the same.

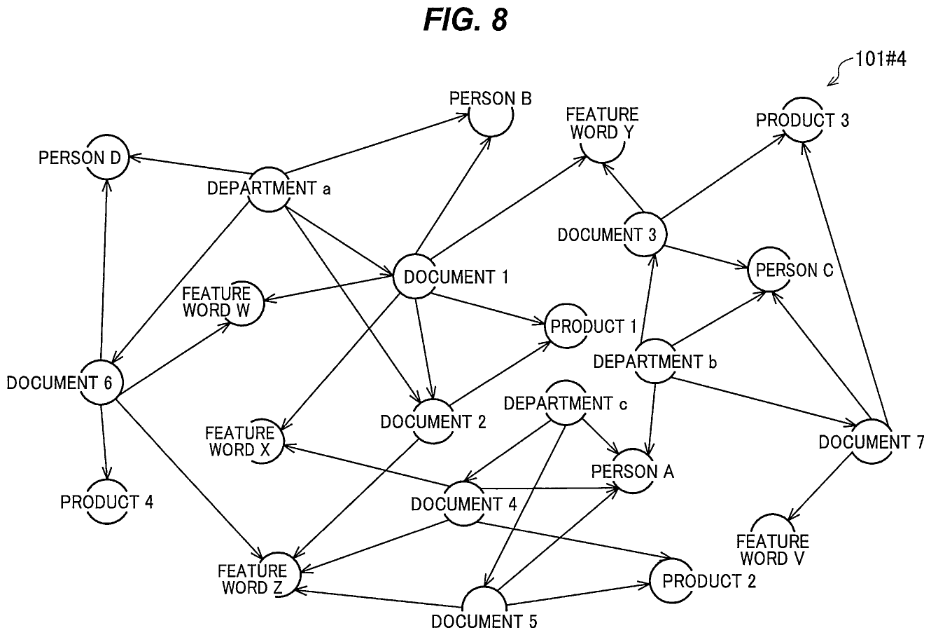

For example, an example case will now be described in which products related to “Feature Word X” and “Feature Word Z” are retrieved from a knowledge graph 101 #4 illustrated in FIG. 8.

First, as a prerequisite, the width of each of “Feature word X” and “Feature word Z” is 30.

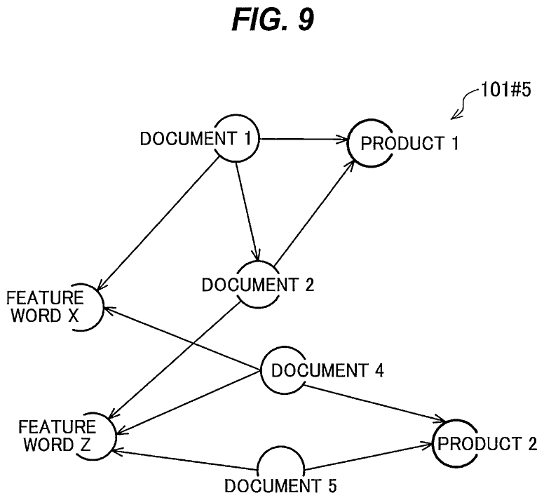

Related products, which are related information related to these feature words are “Product 1” and “Product 2,” as illustrated in the subgraph 101 #5 illustrated in FIG. 9. Since the degree of relatedness between “Feature Word X” and “Product 1” is “1,” and the degree of relatedness between “Feature word X” and “Product 2” is “1”; therefore, the width of each band is ½ of the width of “Feature Word X,” which equals 15.

The degree of relatedness between “Feature Word Z” and “Product 1” is “1,” and the degree of relatedness between “Feature Word Z” and “Product 2” is “2.” Therefore, the width of the band connecting “Feature Word Z” and “Product 1” is ⅓ of the width of the “Feature Word Y,” which equals 10, and the width of the band connecting “Feature Word Z” and “Product 2” is ⅔ of the width of “Feature Word Y,” which equals 20.

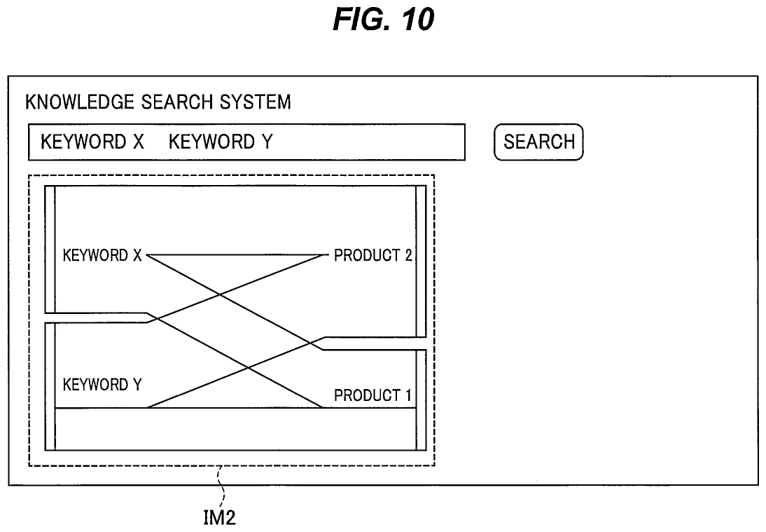

From the above, the width of “Product 1” is 15+10=25, and the width of “Product 2” is 15+20=35. Therefore, in a displayed Sankey diagram IM2, as illustrated in FIG. 10, the width of the Product 2 node is larger than the width of the Product 1 node.

Another example case will now be described in which the relatedness of only one of the input queries is large. Here, the width of the bands is normalized for each keyword. In this way, even when the value of the relatedness of one of the keywords is large, by normalizing the width with each keyword, the results can be prevented from being affected only by the value of relatedness of one of the input queries.

For example, when the degree of relatedness between “Feature Word A” and “Product P” is “18,” the degree of relatedness between “Feature Word A” and “Product Q” is “12,” the degree of relatedness between “Feature Word B” and “Product P” is “1,” and the degree of relatedness between “Feature Word B” and “Product Q” is “4,” then the sum of the degrees of relatedness of “Product P” is 18+1=19, and the sum of the degrees of relatedness of “Product Q” is 12+4=16, which means the degree of relatedness of “Product P” is larger. Here, the relatedness between “Product P” and “Feature Word B” is not high but the relatedness between “Product P” and “Feature Word A” is high; therefore, the overall relatedness of “Product P” is determined to be high.

However, the original intention of the user is to retrieve related information related to both “Feature Word A” and “Feature Word B.” Therefore, in the present generation unit 106 embodiment, the display-data normalizes the band widths on the basis of relatedness. In this example, the width of the band connecting “Feature Word A” and “Product is P” determined to be 30×18÷(18+12)=18, the width of the band connecting “Feature Word A” and “Product Q” is determined to be 30×12÷(18+12)=12, the band connecting “Feature Word B” and “Product P” is determined to be 30×1÷(1+4)=6, and the width of the band connecting “Feature Word B” and “Product Q” is determine to be 30×4÷(1+4)=24. The width of “Product P” is determined to be 18+6=24, and the width of “Product Q” is determined to be 12+24=36. In this way, the width of Product Q can be displayed larger than the width of Product P. As a result of the above, the display-data generation unit 106 can display related information that is strongly related to both “Feature Word A” and “Feature Word B,” which is what the original intent of the user for conducting the search, to the user as high-ranking results. This can also prevent one of the input queries from affecting the overall relatedness.

Here, the importance of each input keyword is assumed to be equal, and thus the widths of the keywords are the same; but for example, the user may specify the degree of importance of each keyword, and the width of the inputted keyword may be changed accordingly. In such the case, the display-data generation unit 106 performs calculation by normalizing each band width in accordance with the set width of the corresponding keyword.

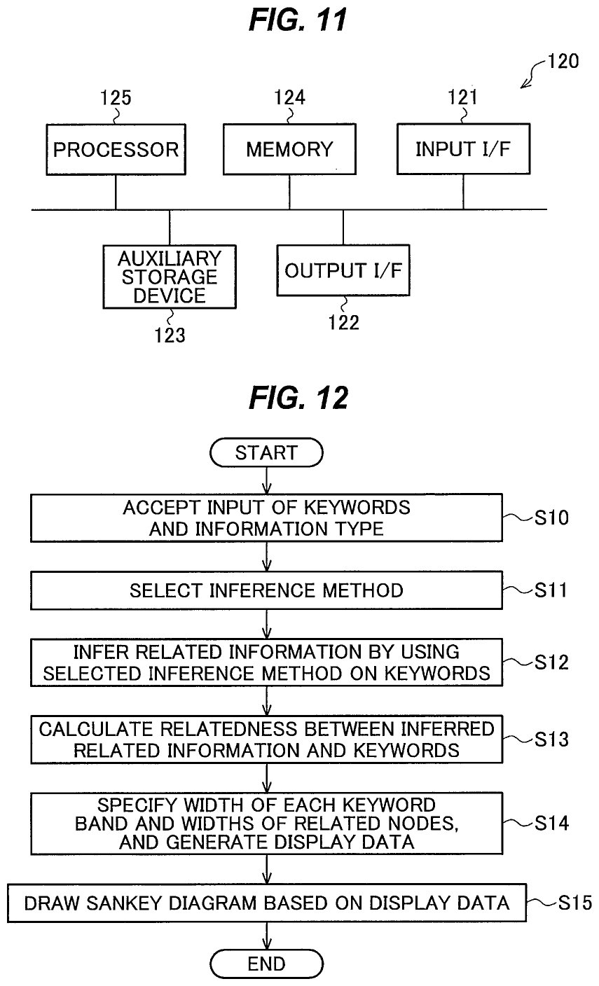

FIG. 11 is a hardware configuration diagram schematically of the related-information display device 100 according to the first embodiment.

As illustrated in FIG. 11, the related-information display device 100 can be implemented by a computer 120 including an input I/F 121, an output I/F 122, an auxiliary storage device 123, a memory 124, and a processor 125.

The input I/F 121 is an input device, such as a keyboard or a mouse, for accepting input from a user. The input I/F 121 functions as an input unit for accepting input from a user.

The output I/F 122 is an output device, such as a display, for providing information to a user. The output I/F 122 functions as a display unit for displaying information to a user.

The auxiliary storage device 123 is storage such as a hard disk drive (HDD) or a solid state drive (SSD) for storing information, such as knowledge graphs, and programs necessary for processing by the related-information display device 100.

The memory 124 is a volatile or nonvolatile memory that provides a work area to the processor 125.

The processor 125 loads a program stored in the auxiliary storage device 123 into the memory 124 and executes the program to execute processing by the related-information display device 100.

For example, the knowledge graph DB 101 can be implemented by the auxiliary storage device 123.

The DB operation unit 102, the user I/F unit 103, the related-information inference unit 104, the relatedness calculation unit 105, and the display-data generation unit 106 can be implemented by the processor 125 loading programs stored in the auxiliary storage device 123 in the memory 124 and executing the programs.

Such programs may be provided over a network or may be recorded and provided on a recording medium. That is, such programs may be provided, for example, as a program product.

FIG. 12 is a flowchart illustrating operation of the related-information display device 100 according to the first embodiment.

First, the user I/F unit 103 accepts input from a user via an input unit (not illustrated) and a display unit (not illustrated) of keywords, the information type of the keywords, and the information type of the target to be retrieved (step S10). In other words, the user I/F unit 103 receives keywords inputted by a user and the information type selected and inputted by the user.

Next, the related-information inference unit 104 selects an inference method for related information on the basis of the information type of the keywords and the information type of the information to be retrieved (step S11). The related-information inference unit 104 selects a method of searching the knowledge graph DB from multiple predetermined search methods in accordance with the information types received from the user I/F unit 103. In other words, the search method to be used is predetermined in accordance with information type.

Next, the related-information inference unit 104 uses the selected inference method to infer related information related to the inputted keywords (step S12). In other words, the related-information inference unit 104 extracts knowledge information related to the keywords received from the user I/F unit 103 from the knowledge graph by using the selected inference method.

Next, the relatedness calculation unit 105 uses a graph structure to calculate the relatedness between each keyword and the inferred related information (step S13). In other words, the relatedness calculation unit 105 calculates the degrees of relatedness by using information such as the number of relayed nodes or their degrees of importance on the basis of the structure of a subgraph including the keywords and the extracted related information.

Next, the display-data generation unit 106 uses the calculated degrees of relatedness to calculate the band widths and the node widths required to prepare a Sankey diagram, and generates display data (step S14). In other words, the display-data generation unit 106 calculates the widths of the bands representing the relationships between the keywords and the related information on the basis of the related information extracted by the related-information inference unit 104 and the degrees of relatedness calculated by the relatedness calculation unit 105, and generates display data. The display-data generation unit 106 normalizes the widths of the bands connecting the keywords and the related information on the basis of the widths of the keywords on the input side, and determines the value of the width of the related information to be the sum of the width of the keyword and the width of the band. The display-data generation unit 106 then generates display data including the above values.

Finally, the user I/F unit 103 draws a Sankey diagram on a display unit (not illustrated) on the basis of the generated display data (step S15). In other words, the user I/F unit 103 draws a Sankey diagram based on the received display data and presents it to the user.

As described above, according to the first embodiment, by representing the relationship between the keywords inputted by a user and the inferred related information in the form of a Sankey diagram, the relationship between the inputted keywords and the obtained related information can be represented by band width. Therefore, a user can easily identify the relationship between the inputted keywords and the obtained related information.

Furthermore, since values obtained by normalizing the degrees of relatedness obtained from a knowledge graph are used to calculate the band widths representing the relationships between the keywords and the related information, information related to both keywords can be displayed at higher ranks, and information desired by the user can be presented.

### Second Embodiment

In the above first embodiment, related information of keywords is displayed; however, in the second embodiment, which is described below, new related information is retrieved and displayed by using the related information obtained from the keywords as input.

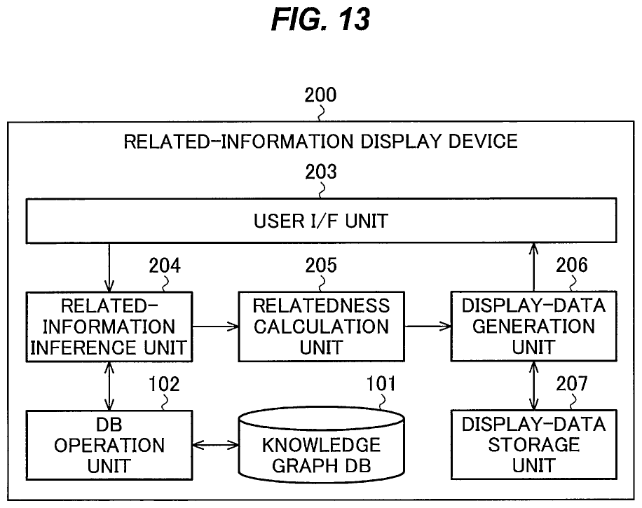

FIG. 13 is a block diagram schematically illustrating a configuration of a related-information display device 200 according to the second embodiment.

The related-information display device 200 includes a knowledge graph DB 101, a DB operation unit 102, a user I/F unit 203, a related-information inference unit 204, a relatedness calculation unit 205, a display-data generation unit 206, and a display-data storage unit 207.

The knowledge graph DB 101 and the DB operation unit 102 of the related-information display device 200 according to the second embodiment are respectively the same as the knowledge graph DB 101 and the DB operation unit 102 of the related-information display device 100 according to the first embodiment.

Similar to the first embodiment, the user I/F unit 203 functions as an input accepting unit that accepts input from a user, and a display processing unit that displays related information. For example, similar to the first embodiment, the user I/F unit 203 presents a search screen that allows a user to retrieve related information, and accepts input from the user of keywords, information types that are the types of information to which the keywords belong, and information type that is the type of the information to be retrieved. The user I/F unit 203 then presents the degrees of relatedness between input queries and related information to the user by using a flow rate diagram on the basis of display data, as in the first embodiment. Here, related information inferred on the basis of keywords inputted by a user is also referred to as first related information. The information type of information to be retrieved and used for the inference of the first related information is also referred to as a first information type.

The user I/F unit 203 accepts input of the type of information to be retrieved from the first related information as user input to a screen displaying the first related information via an input unit (not illustrated).

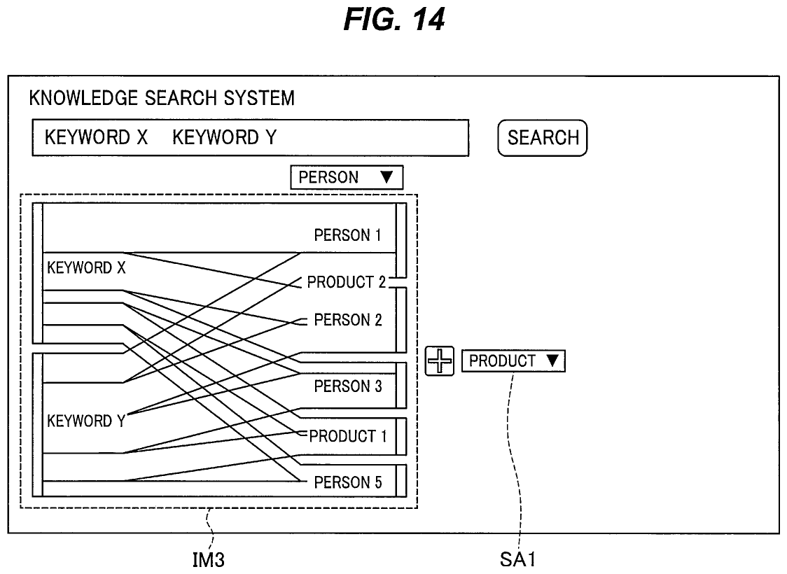

For example, as illustrated in FIG. 14, a selection area SA1 is provided on a screen displaying a Sankey diagram IM3 of the inference result of the first related information, to allow selection of the type of information to be retrieved by using the first related information as keywords; when an information type is selected in the selection area SA1, the user I/F unit 203 gives the first related information to the related-information inference unit 204 so that the first related information is used as keywords to retrieve information of the selected information type. The information type selected here is also referred to as a new information type or a second information type. In other words, in the second embodiment, the user I/F unit 203 acquires a new information type after display data is generated.

Similar to the first embodiment, the related-information inference unit 204 receives user input and infers first related information.

The related-information inference unit 204 then receives keywords that are the first related information and a selected information type from the user I/F unit 203, and on the basis of the received keywords and information type, infers second related information, which is information related to the keywords. For example, the related-information inference unit 204 uses Persons 1 to 5, which is the first related information resulting from the first search, in FIG. 14, as inputted keywords, and uses the DB operation unit 102 and the knowledge graph DB 101 to extract related information of the selected information type from a knowledge graph. In other words, the related-information inference unit 204 uses the first related information as new keywords, and infers information relating to the new keywords and belonging to a new information type as second related information, which is new related information.

Specifically, when the first related information is “person” and information of an information type “product” is to be retrieved as related information related to the persons, the related-information inference unit 204 uses the structure of the knowledge graph to select an inference method of inferring the related information to be products related to documents authored by one of the inputted persons.

The relatedness calculation unit 205 calculates the relatedness between the keywords and the first or second related information from the inference results of the first or second related information. For example, the relatedness calculation unit 205 calculates the relatedness by using the number of relayed nodes on the graph or the degrees of importance of the relayed nodes when the first related information is input nodes and the second related information is output nodes. Specifically, the relatedness calculation unit 205 calculates relatedness by calculating the sum of the number of nodes between input nodes and output nodes. The relatedness calculation unit 205 may calculate relatedness by calculating the sum of the degrees of importance of the relayed nodes.

The relatedness for the first related information is also referred to as first relatedness, and the relatedness for the second related information is also referred to as new relatedness or second relatedness.

The display-data storage unit 207 stores display data generated by the display-data generation unit 206.

Similar to the first embodiment, the display-data generation unit 206 generates display data on the basis of the first related information and its relatedness. The display data generated here is also referred to as first display data.

The display-data generation unit 206 generates display data on the basis of the first related information, the second related information, and their relatedness. The display data generated here is also referred to as new display data or second display data.

However, the first display data also includes data for displaying a selection area for further inference based on the first related information.

For example, the display-data generation unit 206 generates first display data through processing similar to that in the first embodiment and then gives the first display data to the user I/F unit 203 and stores the first display data in the display-data storage unit 207.

Specifically, when the display-data generation unit 206 receives the second related information from the related-information inference unit 204 and the second relatedness from the relatedness calculation unit 205, the display-data generation unit 206 calculates the widths of the bands connecting the first related information and the second related information, which are keywords, and the widths of the second related information through processing similar to that in the first embodiment. The display-data generation unit 206 then reads the first display data stored in the display-data storage unit 207 and generates second display data indicating the widths of the keywords in the first display data, the widths of the bands connecting the keywords and the first related information, the width of the first related information node, the widths of the bands connecting the first related information and the second related information, and the width of the second related information node.

For example, the display-data generation unit 206 determines the widths of the bands connecting the first related information and the second related information on the basis of the width of the first related information node by normalizing the widths of the bands relative to the width of the first related information node in accordance with the degrees of relatedness calculated by the relatedness calculation unit 205. In other words, the display-data generation unit 206 determines the width of each band by dividing the width of the first related information in proportion to the relatedness with the second related information, and determines the width of the second related information node by summing the widths of the bands. In other words, the display-data generation unit 206 connects new keywords and new related information of the new keywords with bands to generate new display data for displaying a new flow rate diagram indicating the relationship between the new keywords and their new related information. Here, the width of a band connecting a new keyword and new related information increases as the new relatedness increases.

The second display data may include, as order information for displaying the first and second related information, sequence information indicating the column numbers of the columns storing the data, information for displaying nodes in descending order of width, information representing a display order for grouping display, or the like.

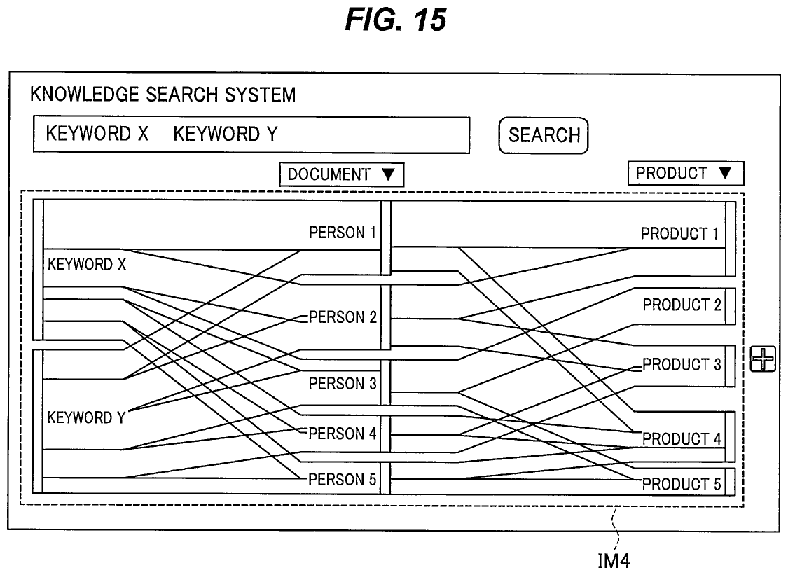

By receiving second display data such as that described above, the user I/F unit 203 causes a display unit (not illustrated) to display a Sankey diagram IM4 including keywords and first and second related information, as illustrated in FIG. 15.

In the Sankey diagram IM4, inputted keywords are displayed at the left end, first related information in the middle, and second related information on the right side of the first related information. The relatedness between the respective search results is indicated by the widths of bands.

Specifically, “Person 1,” “Person 2,” “Person 3,” “Person 4,” and “Person 5,” which are first related information, are displayed as persons related to “Keyword X” and “Keyword Y,” which are inputted keywords.

“Products,” which are information related to “Person 1,” “Person 2,” “Person 3,” “Person 4,” and “Person 5,” are displayed as second related information. Products are displayed as second related information on the right side and are connected to persons with bands whose widths represent the strength of the relationships between the products and the persons; for example, “Product 1” and “Product 4” are related to and thus connected to “Person 1,” “Product 1” and “Product 3” are related to and thus connected to “Person 2,” “Product 2” and “Product 5” are related to and thus connected to “Person 3,” “Product 3” and “Product 4” are related to and thus connected to “Person 4,” and “Product 4” and “Product 5” are related to and thus connected to “Person 5.”

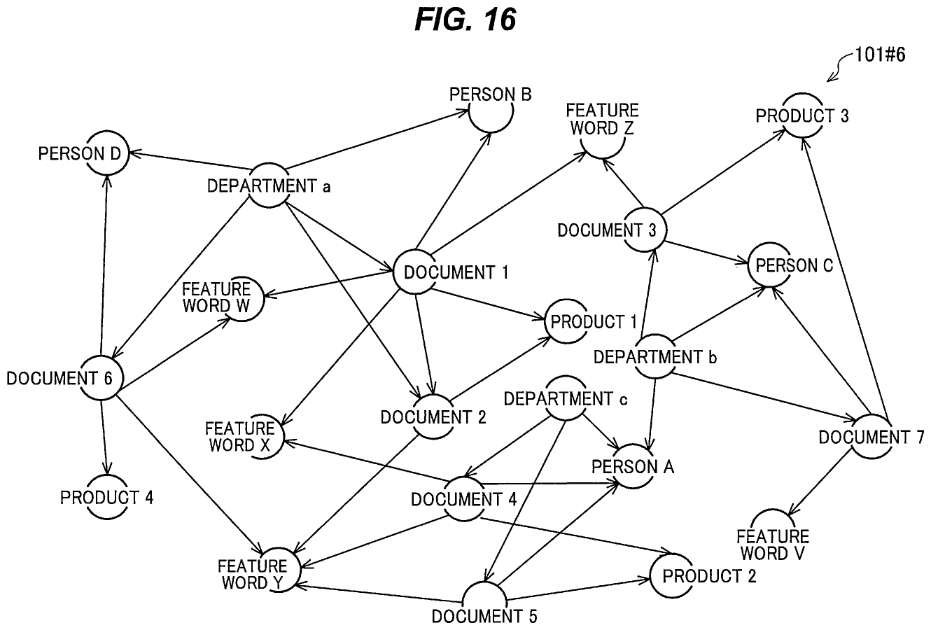

Here, when the first related information is a “persons,” and “products” related to the persons are to be retrieved, the related-information inference unit 204 uses a knowledge graph structure to select an inference method that infers products related to documents authored by one of the persons to be related information. For example, in a subgraph 101 #6 illustrated in FIG. 16, “Product 1,” “Product 2,” and “Product 3” related to “Document 2,” “Document 3,” “Document 4,” and “Document 5” authored by “Person A,” and “Product 1” and “Product 4” related to “Document 1” and “Document 6” authored by “Person B” are inferred to be related second product information. Alternatively, an inference method of performing calculation from a knowledge graph using PageRank, etc., or other inference methods may be selected.

The related-information display device 200 described above can also be implemented by the computer 120 as illustrated in FIG. 11. For example, the display-data storage unit 207 can be implemented by the auxiliary storage device 123.

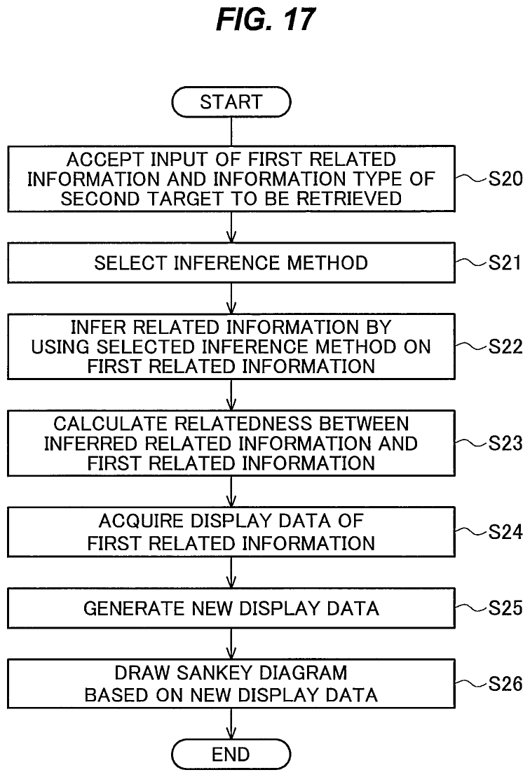

FIG. 17 is a flowchart illustrating operation of the related-information display device 200 according to the second embodiment.

Since the operation by the related-information display device 200 according to the second embodiment up to the step of displaying the first related information is the same as the operation by the related-information display device 100 according to the first embodiment, here, the operation from steps of displaying the first related information to displaying the second related information will be explained.

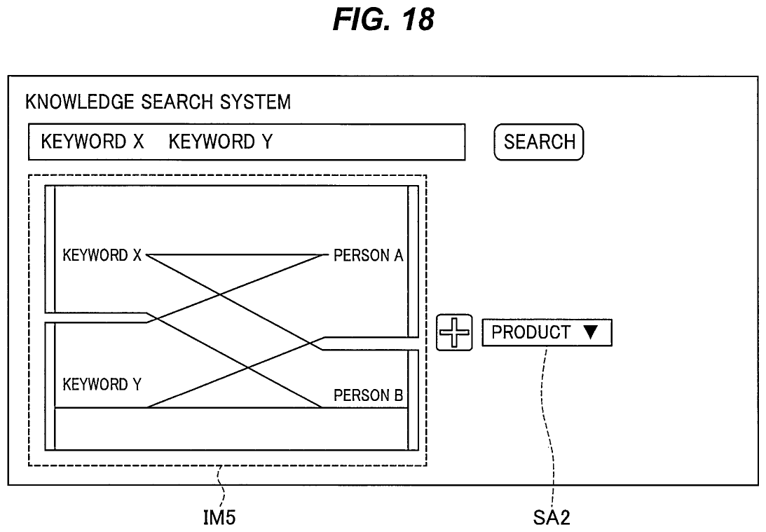

First, the user I/F unit 203 accepts user input of an information type of the second related information to be retrieved via a screen including a flow rate diagram representing the first related information (step S20). Here, the user I/F unit 203 accepts selection by a user of the information type of the second related information in order to display information related to the first related information. For example, in the example illustrated in FIG. 18, a Sankey diagram IM5 shows first related information “Person A” and “Person B” related to “Keyword X” and “Keyword Y,” and a selection area SA2 that allows a user to select an information type for retrieving second related information related to the first related information “Person A” and “Person B.” Here, “product” is selected as the information type of the second related information.

Next, the related-information inference unit 204 selects an inference method on the basis of the information type of the first related information and the information type of the second related information (step S21). In other words, the related-information inference unit 204 selects a knowledge graph inference method predetermined in accordance with the information type of the first related information and the information type of the second related information received from the user I/F unit 203. In the example illustrated in FIG. 18, in order to infer related “products” from “persons,” an inference method is selected to retrieve “documents” authored by a “person” and further extracting “products” related to the “documents” as second related information.

Next, the related-information inference unit 204 infers second related information for the first related information by using the selected inference method (step S22). In other words, the related-information inference unit 204 extracts knowledge information related to the first related information received from the user I/F unit 203 from the knowledge graph by using the selected inference method. In the example illustrated in FIG. 16, documents authored by Person A are “Document 2,” “Document 3,” “Document 4,” and “Document 5,” and products related to these documents are “Product 1,” “Product 2,” and “Product 3,” so product information related to “Person A” is “Product 1,” “Product 2,” and “Product 3.”

Documents authored by “Person B” are “Document 1” and “Document 6,” and products related to these documents are “Product 1” and “Product 4,” so products related to “Person B” are “Product 1” and “Product 4.”

Next, the relatedness calculation unit 205 uses a graph structure to calculate the relatedness between the first related information and the inferred second related information (step S23). In other words, the relatedness calculation unit 205 calculates the relatedness by using information such as the number of relayed nodes or the degree of importance of the relayed nodes on the basis of a subgraph structure including the first related information that are the keywords and the extracted second related information.

In the subgraph 101 #6 illustrated in FIG. 16, since “Person A” and “Product 1” are related via “Document 2,” the number of relayed nodes is “1,” and since “Document 2” has a high degree of importance and is referred to by other documents, the degree of importance is “2.” Therefore, their degree of relatedness is calculated by the relatedness calculation unit 205 to be 2×1=2.

Since “Person A” and “Product 2” are related via “Document 3” and “Document 4,” the number of relayed nodes is “2,” and the degree of importance of each of these documents is “1.” Therefore, their degree of relatedness is calculated by the relatedness calculation unit 205 to be 1×2=2.

Since “Person A” and “Product 3” are related via “Document 5,” the number of relayed nodes is “1,” and its degree of importance is “1.” Therefore, their degree of relatedness is calculated by the relatedness calculation unit 205 to be 1×1=1.

Similarly, since “Person B” and “Product 1” are related via “Document 1,” the number of relayed nodes is “1,” and its degree of importance is “1.” Therefore, their degree of relatedness is calculated by the relatedness calculation unit 205 to be 1×1=1.

Referring back to FIG. 17, the display-data generation unit 206 then acquires display data for the first related information stored in the display-data storage unit 207 (step S24). The display-data generation unit 206 then specifies the widths of the keyword nodes, the width of the first related information node, and the widths of the bands connecting the keywords and the first related information as display data for the keywords of the input queries already displayed to the user and the first related information.

For example, in the example illustrated in FIG. 18, the width of each of nodes of “Keyword X” and “Keyword Y,” or feature words, is “50,” the width of the node of “Person A,” or the first related information, is “65,” and the width of the node of “Person B” is “35.” The width of the band connecting “Keyword X” and “Person A” is “35,” the width of the band connecting “Keyword Y” and “Person A” is “30,” the width of the band connecting “Keyword X” and “Person B” is “15,” and the width of the band connecting “Keyword Y” and “Person B” is “20.”

Next, the display-data generation unit 206 uses the calculated degrees of relatedness to calculate the band widths and the node widths required to prepare a Sankey diagram, and generates new display data (step S25). For example, the display-data generation unit 206 calculates the widths of bands representing the relatedness between the first related information and the second related information on the basis of the second related information inferred by the related-information inference unit 204 and the relatedness calculated by the relatedness calculation unit 205, and generates new display data. Here, the display-data generation unit 206 normalizes the widths of the bands connecting the first related information and the second related information on the basis of the width of the first related information node of the input side, and determines the width of the second related information node to be the sum of the band widths.

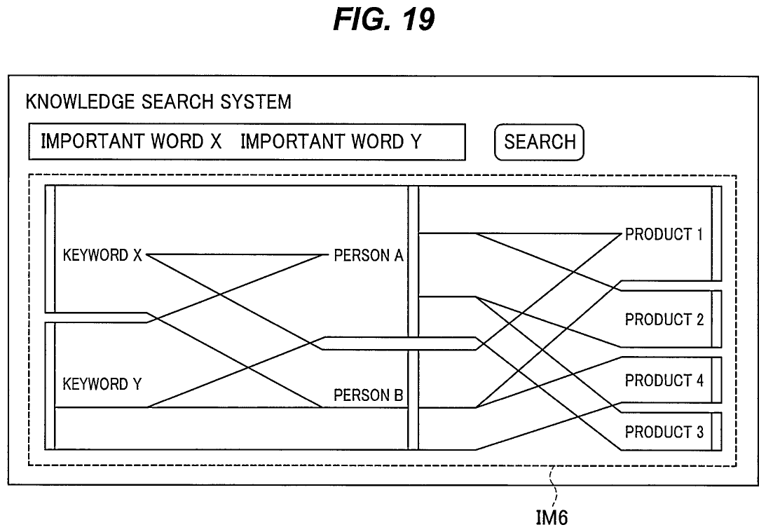

FIG. 19 is a schematic diagram illustrating an example screen including a Sankey diagram IM6 drawn using new display data.

In the example illustrated in FIG. 19, the widths of the bands connecting the first related information and the second related information and the width of the second related information node are determined as follows.

The width of the “Person A” node is “65,” and products related to “Person A” are “Product 1” having a degree of relatedness of 2, “Product 2” having a degree of relatedness of 2, and “Product 3” having a degree of relatedness of 1. The display-data generation unit 206 calculates (input side node width)× (degree of relatedness)/(total degree of relatedness) in order to normalize the band width in accordance with the relatedness of related products. Thus, the width of the band connecting “Person A” and “Product 1” is 65×2/(2+2+1)=26. Similarly, the width of the band connecting “Person A” and “Product 2” is 65×2/(2+2+1)=26, and the width of the band connecting “Person A” and “Product 1” is 65×1/(2+2+1)=13.

The width of the band connecting “Person B” and “Product 1” is 35×1/(1+1)=17.5, and the width of the band connecting “Person B” and “Product 4” is also 35×1/(1+1)=17.5.

From the above, since the width of the “Product 1” node equals the sum of the widths of the bands extending from “Person A” and “Person B,” the width of the “Product 1” is 26+17.5=43.5. The widths of the “Product 2” node, “Product 3” node, and “Product 4” node are 26, 13, and 17.5, respectively.

Referring back to FIG. 17, finally, the user I/F unit 203 draws a Sankey diagram based on new display data (step S26). For example, the user I/F unit 203 draws a Sankey diagram based on the received display data and presents it to a user.

As described above, according to the second embodiment, by further displaying information related to the related information by using the retrieved results as input, more related information can be retrieved without restarting the search, and the relationship between the pieces of related information can be presented, so related information desired by a user can be found more efficiently.

Since the width of a first information node closely related to input queries is increased, and the width is used to represent the width of further related information, the degree of relatedness to the inputted queries can be easily read by looking at the band width.

The second embodiment describes a method of displaying second related information by using first related information; similarly, third related information can be displayed by using second related information as input queries, and furthermore, fourth related information can be displayed by using third related information as input queries. In other words, related information can be retrieved one after another by using the search results of related information.

### Third Embodiment

In the first embodiment, a user inputs keywords; however, in the third embodiment, keywords are automatically extracted from inputted text or document, and the keywords and feature words as related information can be presented.

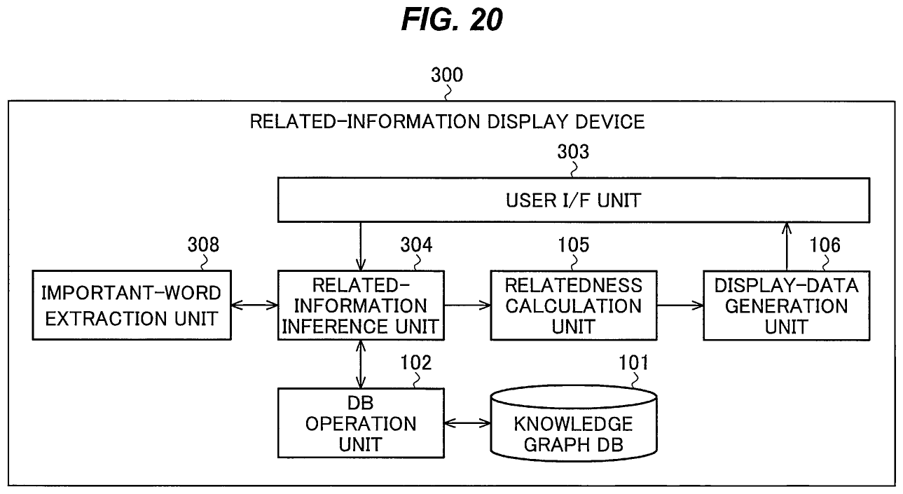

FIG. 20 is a block diagram schematically illustrating a configuration of a related-information display device 300 according to the third embodiment.

The related-information display device 300 includes a knowledge graph DB 101, a DB operation unit 102, a user I/F unit 303, a related-information inference unit 304, a relatedness calculation unit 105, a display-data generation unit 106, and an important-word extraction unit 308.

The knowledge graph DB 101, the DB operation unit 102, the relatedness calculation unit 105, and the display-data generation unit 106 of the related-information display device 300 according to the third embodiment are respectively the same as the knowledge graph DB 101, the DB operation unit 102, the relatedness calculation unit 105, and the display-data generation unit 106 of the related-information display device 100 according to the first embodiment.

Similar to the first embodiment, the user I/F unit 303 accepts user input of keywords and the information type of the keywords. Since the operation of the related-information display device 300 in this case is the same as that of the related-information display device 100 according to the first embodiment, explanation is omitted below.

The user I/F unit 303 according to the third embodiment can also accept user input of text or a document and the information type of the information to be retrieved in place of keywords and the information type. In this way, the user I/F unit 303 acquires text and information type. The user I/F unit 303 then gives the acquired text to the related-information inference unit 304. The user input may be in any format, such as text data or document files, that can acquire text. For example, as a method of accepting text from a user, an input box may accept input of a character string or a file name of a document file. When a file name of a document file is accepted, the user I/F unit 303 may extract text data from the document file with that file name as text and give the text to the related-information inference unit 304.

Similar to the first embodiment, the user I/F unit 303 receives display data from the display-data generation unit 106 and, on the basis of the display data, presents to a user the relatedness between input queries and related information by using a flow rate diagram.

Similar to the second embodiment, the user I/F unit 303 can accept input of the type of information to be further retrieved on a screen displaying the related information and provide information related to the related information.

The related-information inference unit 304 passes the text received from the user I/F unit 303 to the important-word extraction The unit 308. The related-information inference unit 304 then receives the extracted important words from the important-word extraction unit 308.

The related-information inference unit 304 uses the received important words as keywords, determines the information type to be “feature word,” determines an inference method on the basis of the information type of information to be retrieved inputted by a user, and infers related information. Here, the related-information inference unit 304 infers information related to the keywords and belonging to the information type of the information to be retrieved to be related information. The related-information inference unit 304 then passes the inferred related information to the relatedness calculation unit 105.

The important-word extraction unit 308 extracts important words from the text received from the related-information inference unit 304. The extracted important words are passed to the related-information inference unit 304. The important words may be extracted using known techniques. For example, the important-word extraction unit 308 morphologically analyzes the text and extracts important words from the text by using term frequency-inverse document frequency (TF-IDF). Additionally, words registered in advance or nouns may be extracted as important words. Since the important words extracted here are treated as keywords, the important-word extraction unit 308 functions as a keyword extraction unit that extracts keywords from text.

The processing by the relatedness calculation unit 105 and the display-data generation unit 106 is the same as that in the first embodiment. However, the display-data generation unit 106 may change the widths of keywords that are important words in accordance with the degree of importance (for example, the degree of importance calculated by TF-IDF) in the extraction of important words by the important-word extraction unit 308. Alternatively, a user may determine the widths of the bands of inputted keywords.

The related-information display device 300 described above can also be implemented by the computer 120 as illustrated in FIG. 11. For example, the important-word extraction unit 308 can be implemented by the processor 125 loading a program stored in the auxiliary storage device 123 in the memory 124 and executing the program.

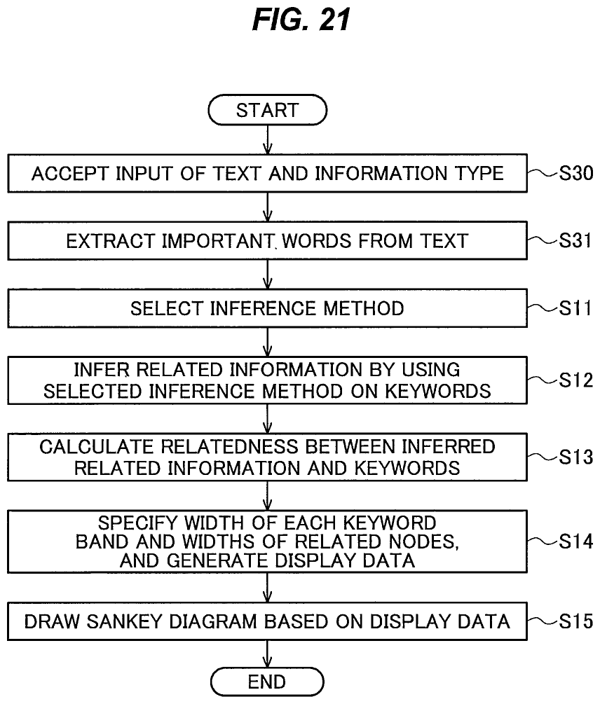

FIG. 21 is a flowchart illustrating operation of the related-information display device 300 according to the third embodiment.

In the flowchart illustrated in FIG. 21, steps of performing the same processing as the flowchart of the first embodiment illustrated in FIG. 12 are marked with the same reference sign as in FIG. 12.

First, the user I/F unit 203 acquires text and the information type of the information to be retrieved from a user (step S30). For example, the user I/F unit 203 accepts user input of a character string or a file name of a document file to an input box. Here, when the user input is a file name of a document file, the user I/F unit 203 extracts text from the document file. Specifically, the user I/F unit 203 accesses the document file and extracts text from the document file. The text is given to the important-word extraction unit 308 via the related-information inference unit 304.

Next, the important-word extraction unit 308 extracts important words from the text from the related-information inference unit 304 (step S31). For example, the important-word extraction unit 308 performs important-word extraction processing on the text, extracts important words, and gives them to the related-information inference unit 304 as inputted keywords used as related information.

The processing of steps S11 to S15 in FIG. 21 is the same as the processing of steps S11 to S15 in FIG. 12.

However, the related-information inference unit 304 infers related information by using the important words from the important-word extraction unit 308 as keywords having an information type of “feature word.”

As described above, the third embodiment enables retrieval of related information from text, so that a user can obtain related information without considering keywords, and thus information desired by the user can be easily obtained.

Since automatically extracted important words are presented and a user can make corrections, such as deletion, it is possible to conduct a search by using only keywords that are more important to the user, and results desired by the user can be presented.

Here, important words automatically extracted from text are displayed as input nodes, but document files may be displayed as input nodes, and related information obtained from important words may be displayed as information related to the files in the form of a Sankey diagram. In this way, when multiple document files are inputted, information related to the files can be obtained without a user providing important keywords.

### Fourth Embodiment

In the first or third embodiment described above, related information is retrieved by using a data structure on a knowledge graph; here, the fourth embodiment describes a case in which a database other than the knowledge graph DB 101 is used together with the knowledge graph DB 101 to retrieve related information.

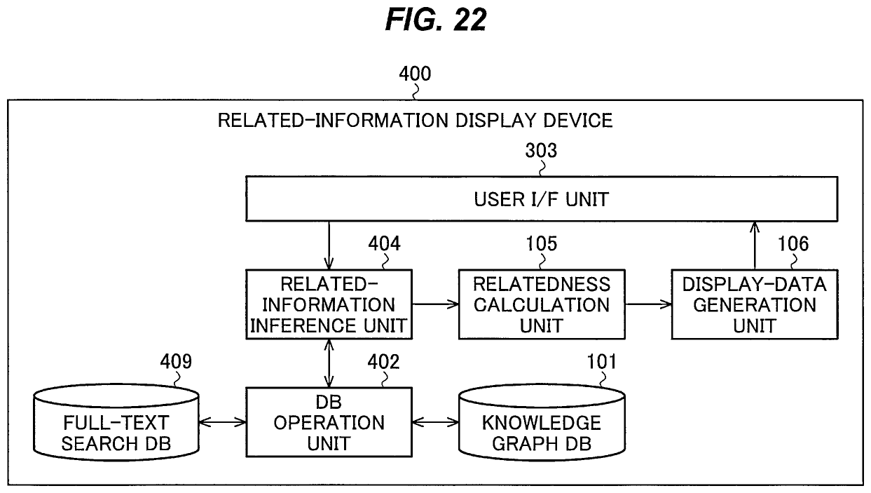

FIG. 22 is a block diagram schematically illustrating a configuration of a related-information display device 400 according to the fourth embodiment.

The related-information display device 400 includes a knowledge graph DB 101, a DB operation unit 402, a user I/F unit 303, a related-information inference unit 404, a relatedness calculation unit 105, a display-data generation unit 106, and a full-text search DB 409.

The knowledge graph DB 101, the relatedness calculation unit 105, and the display-data generation unit 106 of the related-information display device 400 according to the fourth embodiment are respectively the same as the knowledge graph 101, the relatedness calculation unit 105, and the display-data generation unit 106 of the related-information display device 100 according to the first embodiment.

The user I/F unit 303 of the related-information display device 400 according to the fourth embodiment is the same as the user I/F unit 303 of the related-information display device 300 according to the third embodiment. Thus, the user I/F unit 303 according to the fourth embodiment accepts input of keywords and their information types, or sentences or text, and information types of the information to be retrieved. In other words, the user I/F unit 303 functions as an interface unit that acquire keywords or text.

The related-information inference unit 404 receives keywords or text, and their information type from the user I/F unit 303, and, in accordance with these, selects an inference method that also uses full-text. In other words, the related-information inference unit 404 searches the full-text search DB 409 for documents related to the keywords or text, and infers related information related to the retrieved documents by using a knowledge graph structure.

For example, the related-information inference unit 404 causes the DB operation unit 402 to perform a full-text search by using inputted keywords or text as queries, and acquires document information indicating related documents in order of relatedness from the DB operation unit 402. The related-information inference unit 404 then causes the DB operation unit 402 to retrieve related information by inputting the documents in the document information that is the search results into the knowledge graph DB 101.

Specifically, when the inputted keywords are “knowledge graph” and “summary,” and the information type of information to be retrieved is “person,” the related-information inference unit 404 causes the DB operation unit 402 to search the full-text search DB 409 for documents related to the words “knowledge graph” and “summary.” As a result of the search, “Document 1,” “Document 2,” and “Document 3” are retrieved for the word “knowledge graph,” and “Document 2,” “Document 4,” and “Document 5” are retrieved for the word “summary,” as documents having high relatedness. The related-information inference unit 404 may specify documents having high relatedness by using a threshold value, or may specify a predetermined number of documents in descending order of relatedness.

Next, the related-information inference unit 404 causes the DB operation unit 402 to input “Document 1,” “Document 2,” and “Document 3” to the knowledge graph DB 101 and search the knowledge graph DB 101 for persons related to these documents (for example, information on the authors of the documents). The information type of “Document 1,” “Document 2,” and “Document 3” is “document.” Here, it is assumed that “Person A” and “Person B” are retrieved. Similarly, the related-information inference unit 404 cause the DB operation unit 402 to input “Document 2,” “Document 4,” and “Document 5” to the knowledge graph DB 101 and search the knowledge graph DB 101 for persons related to these documents. Here, it is assumed that “Person A”, “Person B”, and “Person C” are retrieved. In this case, as a search result, the DB operation unit 402 returns “Person A” and “Person B” to the related-information inference unit 404 as persons related to “knowledge graph” and “summary.”

As described above, the related-information inference unit 404 according to the fourth embodiment infers documents related to keywords or text from multiple documents containing the text indicated in the text information stored in the full-text search DB 409, and infers related information related to the related documents from a knowledge graph.

The full-text search DB 409 is a database that stores text information indicating the text of documents represented by nodes of a “document” information type in the knowledge graph DB 101. In other words, the full-text search DB 409 functions as a text-information storage unit that stores text information indicating text of multiple documents.

The DB operation unit 402 receives keywords or text from the related-information inference unit 404, performs a full-text search on the text information stored in the full-text search DB 409 by using the keywords or text, and retrieves documents in order of relatedness indicating the degree of relatedness between the documents and the keywords or text. The DB operation unit 402 then gives document information indicating the retrieved documents to the related-information inference unit 404.

The related-information display device 400 described above can also be implemented by the computer 120 as illustrated in FIG. 11. For example, the full-text search DB 409 can be implemented by the auxiliary storage device 123.

As described above, according to the fourth embodiment, it is possible to extract related documents not displayed on a knowledge graph by also using the full-text search DB 409 for inference of related information. Thus, a larger amount of related information can be presented to a user, and every piece of desired information can be presented.

In the third embodiment, when a file name of a document file is inputted, related information is extracted by extracting important words from the text of the document and performing a search based on the important words, which are keywords. In the fourth embodiment, the text received by the related-information inference unit 404 is used as input for a full-text search, and related information is extracted by extracting documents similar to the text. In this way, there is no need for a user to consider important words, and since documents more similar to the inputted text can be extracted by inputting the entire text, related information more desired by the user can be presented.

### Fifth Embodiment

The fifth embodiment describes a case in which the related information of the first to fourth embodiments is further provided with detailed information.

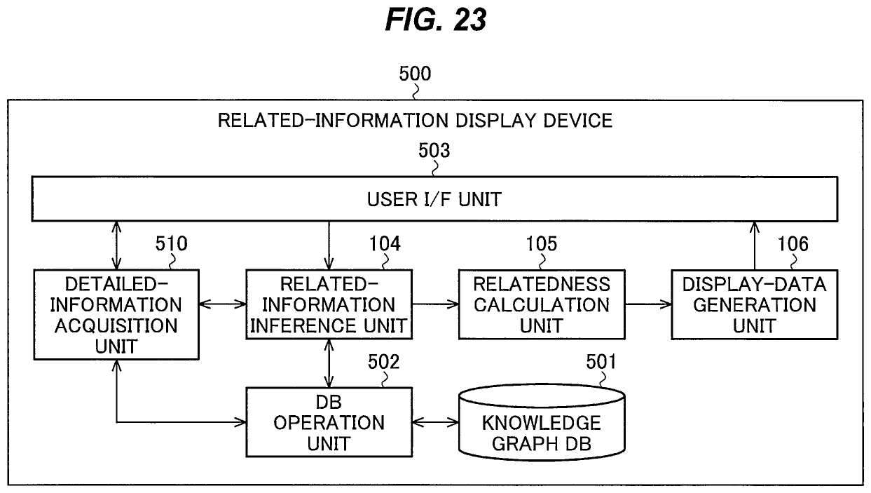

FIG. 23 is a block diagram schematically illustrating a configuration of a related-information display device 500 according to the fifth embodiment.

The related-information display device 500 includes a knowledge graph DB 501, a DB operation unit 502, a user I/F unit 503, a related-information inference unit 104, a relatedness calculation unit 105, a display-data generation unit 106, and a detailed-information acquisition unit 510.

The related-information inference unit 104, the relatedness calculation unit 105, and the display-data generation unit 106 of the related-information display device 500 according to the fifth embodiment are respectively the same as the related-information inference unit 104, the relatedness calculation unit 105, and the display-data generation unit 106 of the related-information display device 100 according to the first embodiment.

The knowledge graph DB 501 holds knowledge information, as in the first embodiment.

The knowledge graph DB 501 according to the fifth embodiment also stores detailed information related to each node constituting a knowledge graph, which is knowledge information. Detailed information is, for example, node property information or adjacent node information. When the related information is “document,” its property information is, for example, information such as the title, creation date, update date, or number of pages; and the adjacent node information is information indicating nodes adjacent to nodes corresponding to the related information, such as nodes of persons who are authors, inspectors, updaters, etc., nodes of issuing departments, and nodes of related products, projects, solutions, etc.

In addition to performing processing similar to that in the first embodiment, the DB operation unit 502 acquires detailed information related to the related information received from the detailed-information acquisition unit 510 from the knowledge graph DB 501 in response to instructions from the detailed-information acquisition unit 510, and gives the detailed information to the detailed-information acquisition unit 510.

In addition to processing similar to that performed by the user I/F unit 103 according to the first embodiment, the user I/F unit 503 performs the following processing.

When the user I/F unit 503 receives display data from the display-data generation unit 106, the user I/F unit 503 receives related information and detailed information on bands contained in the display data from the detailed-information acquisition unit 510. Similar to the first embodiment, the user I/F unit 503 then displays a flow rate diagram based on the display data on a display unit (not illustrated), and when an instruction is received from a user, causes a display unit (not illustrated) to display related information or detailed information on the bands on the flow rate diagram.

The detailed-information acquisition unit 510 receives related information from the user I/F unit 503 and acquires detailed information from the knowledge graph DB 501 by using the DB operation unit 502. In other words, in order to obtain detailed information on the related information received from the user I/F unit 503, the detailed-information acquisition unit 510 uses the DB operation unit 502 to acquire the detailed information from the knowledge graph DB 501.

Alternatively, the detailed-information acquisition unit 510 may acquire band information representing the relationship between keywords and related information as detailed information. Band information is information used by the related-information inference unit 104 for an inference method for the related information. In other words, when the nodes to be relayed are determined to make an inference by using a knowledge graph structure, the band information is the information indicating the relayed node. Furthermore, the band information may further contain property information and adjacent node information of the relayed nodes. The band information may further contain information on the relatedness of the bands.

The detailed-information acquisition unit 510 gives detailed information such as that described above to the user I/F unit 503.

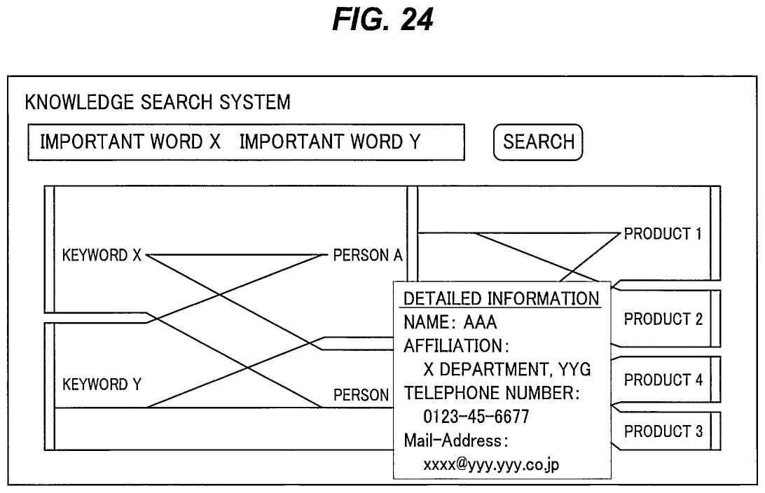

The user I/F unit 503 presents the acquired detailed information to a user. For example, when a Sankey diagram is displayed on a display unit (not illustrated), detailed information of related information included in the Sankey diagram is displayed in a popup in response to a user clicking on the related information in the Sankey diagram via an input unit (not illustrated). For example, FIG. 24 is a schematic diagram illustrating an example of a popup displaying detailed information. When the user I/F unit 503 displays a Sankey diagram on a display unit (not illustrated) via a browser, detailed information may be displayed on a browser tab. In other words, the user I/F unit 503 according to the fifth embodiment acquires an instruction to acquire detailed information of related information or bands and causes the detailed-information acquisition unit 510 to acquire corresponding detailed information in response to the instruction.

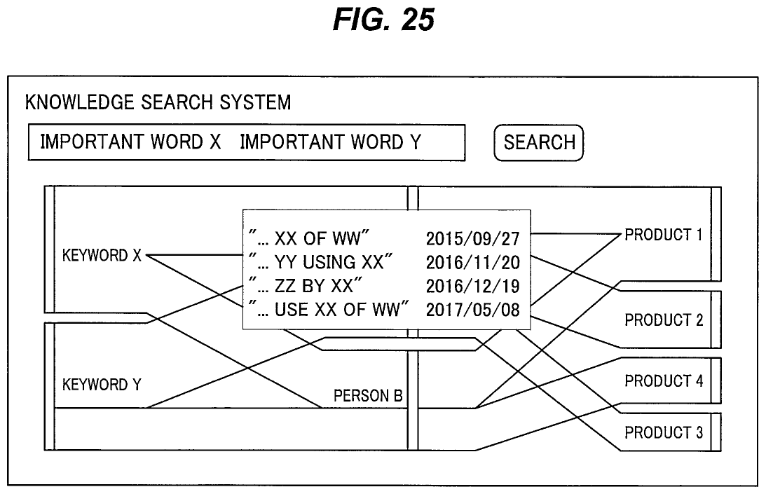

When a user clicks on a band included in a Sankey diagram displayed on a display unit (not illustrated) via an input unit (not illustrated), the user I/F unit 503 may display a list of detailed information on relayed nodes in a popup on the basis of the band information and further display detailed relayed node information. For example, FIG. 25 is a schematic diagram illustrating an example in which band information is displayed as detailed information.

The related-information display device 500 described above can also be implemented by the computer 120 as illustrated in FIG. 11. For example, the detailed-information acquisition unit 510 can be implemented by the processor 125 loading a program stored in the auxiliary storage device 123 in the memory 124 and executing the program.

As described above, according to the fifth embodiment, a user can easily determine which piece of related information is the more desired one by obtaining detailed information on the related information.

Note that the user I/F unit 503 may include a filtering unit (not illustrated) that is a filter that uses detailed information to filter the related information to be displayed on a display unit (not illustrated) and extract only a portion of the related information that relates to specified display data. The filtering unit uses detailed information to filter related information.

The filtering unit extracts only a portion of display data that satisfy conditions specified by a user via an input unit (not illustrated), and the user I/F unit 503 updates the display data by using only the extracted portion. In other words, the user I/F unit 503 presents property information or adjacent node information obtained with detailed information to a user as filter information, and by allowing the user to select conditions for the filter unit, only related information satisfying specific conditions can be displayed. At that time, the filter unit may perform filtering with band information. For example, only results having a certain value in the property, only bands containing a specific property in the detailed information, or only related information having relatedness higher than the specific value are displayed.

By presenting only related information satisfying conditions specified by a user, the user is prevented from seeing unnecessary information when searching for related information and can readily retrieve only necessary information.

What is claimed is:

1. A related-information display device comprising:
a processor to execute a program; and
a memory to store the program which, when executed by the processor, performs a process of, generating display data for displaying a flow rate diagram indicating a relationship between a keyword and related information related to the keyword by connecting the keyword and the related information with a band,
wherein the width of the band increases as the relationship becomes stronger.

2. A related-information display device according to claim 1, further comprising storage to store a knowledge graph holding knowledge information with a plurality of nodes and links connecting the nodes; wherein,
the processor infers the related information related to the keyword from the knowledge graph, and calculates relatedness between the keyword and the related information, and
the width of the band increases as the relatedness increases.

3. The related-information display device according to claim 2, wherein the flow rate diagram is a Sankey diagram.

4. The related-information display device according to claim 3, wherein the width of the band is normalized in the Sankey diagram on a basis of a width with which the keyword is displayed.

5. The related-information display device according to claim 2, wherein the processor acquires the keyword and an information type and infers information related to the keyword and belonging to the information type as the related information.

6. The related-information display device according to claim 2, wherein the processor acquires text and an information type, extracts the keyword from the text, and infers information related to the keyword and belonging to the information type as the related information.

7. The related-information display device according to claim 5, wherein,
the processor acquires a new information type after the display data is generated, uses the related information as a new keyword, infers information relating to the new keyword and belonging to the new information type as new related information, calculates new relatedness being relatedness between the new keyword and the new related information, and connects the new keyword and the new related information related to the new keyword with a band to generate new display data for displaying a new flow rate diagram indicating a relationship between the new keyword and the new related information, and
the width of the band connecting the new keyword and the new related information increases as the new relatedness increases.

8. The related-information display device according to claim 6, wherein,
the processor acquires a new information type after the data is display generated, uses the related information as a new keyword, infers information relating to the new keyword and belonging to the new information type as new related information, calculates new relatedness being relatedness between the new keyword and the new related information, and connects the new keyword and the new related information related to the new keyword with a band to generate new display data for displaying a new flow rate diagram indicating a relationship between the new keyword and the new related information, and
the width of the band connecting the new keyword and the new related information increases as the new relatedness increases.

9. The related-information display device according to claim 2, wherein,
the storage stores text information indicating text of each of a plurality of document; and
the processor acquires the keyword or text, infers a document related to the keyword or the text from the plurality of documents, and infers the related information related to the related document from the knowledge graph.

10. The related-information display device according to claim 5, wherein,
the processor acquires an instruction to acquire detailed information related to the related information or the band, and acquires detailed information related to the related information or the band in response to the instruction.

11. The related-information display device according to claim 10, wherein the processor filters the related information with the detailed information.

12. A non-transitory computer-readable storage medium storing a program that causes a computer to execute processing comprising: generating display data for displaying a flow rate diagram indicating a relationship between a keyword and related information related to the keyword by connecting the keyword and the related information with a band,
wherein the width of the band increases as the relationship becomes stronger.

13. A related-information display method comprising:
generating display data for displaying a flow rate diagram indicating a relationship between a keyword and related information related to the keyword by connecting the keyword and the related information with a band,
wherein the width of the band increases as the relationship becomes stronger.
